(19) United States
(12) Patent Application Publication
(10) Pub. No.: US 2018/0123965 A1
(43) Pub. Date: May 3, 2018

(54) METHOD FOR PACKET TRANSMISSION APPARATUS TO TRANSMIT PACKET IN REAL TIME, PACKET TRANSMISSION APPARATUS, AND COMPUTER PROGRAM

(71) Applicant: SAMSUNG SDS CO., LTD., Seoul (KR)

(72) Inventors: Kyu Sang LEE, Seoul (KR); Ki Woon SUNG, Seoul (KR); Eil Woo BAIK, Seoul (KR); Jae Seok LEE, Seoul (KR); Jun Ho KANG, Seoul (KR); Seong Hun SHIN, Seoul (KR)

(73) Assignee: SAMSUNG SDS CO., LTD., Seoul (KR)

(21) Appl. No.: 15/798,791

(22) Filed: Oct. 31, 2017

(30) Foreign Application Priority Data
Oct. 31, 2016 (KR) 10-2016-0142865

(51) Int. Cl. H04L 12/835; H04L 29/06; H04L 12/851; H04L 12/865

(52) U.S. Cl. CPC H04L 47/30; H04L 65/80; H04L 47/12; H04L 47/6275; H04L 47/24

(57) ABSTRACT

Provided is a method for a packet transmission apparatus to transmit a packet in real time, the method comprises determining, by the packet transmission apparatus, whether a buffer occupancy (an occupancy of a buffer) is a threshold value or more, in response to the buffer occupancy is greater than or equal to the threshold value, extracting, by the packet transmission apparatus, a degree of influence of the packet on quality of experience (QoE) and in response to the degree of influence of the packet on QoE is less than or equal to a predetermined value, dropping, by the packet transmission apparatus, the packet before the packet is transmitted to a network.

This application claims priority from Korean Patent Application No. 10-2016-0142865 filed on Oct. 31, 2016 in the Korean Intellectual Property Office, the disclosure of which is incorporated herein by reference in its entirety.

### BACKGROUND

### 1. Field of the Disclosure

The present disclosure relates to a packet transmission method and apparatus, and more particularly, to a method of adjusting traffic by intentionally dropping a multimedia packet transmitted via a network or duplicating a multimedia packet to improve service quality when a multimedia is provided in real time and an apparatus for performing the method.

### 2. Description of the Related Art

A multimedia provided via a network generally has a large amount of data. However, when the multimedia includes audio or video, it is required to play the multimedia in real time. Therefore, a service employing real-time multimedia data transmission reacts to a change in network features (a bandwidth, a round trip time, a one-way delay, packet loss, jitter, etc.) very sensitively.

For example, congestion may increase in a network section, and an available bandwidth may be reduced. In this case, when a multimedia data sender does not decrease a transmission rate according to the reduced available bandwidth, network congestion may be further aggravated. Then, a receiver may not receive data in real time. This may degrade quality of experience (QoE) and leads to dissatisfaction of a user.

Also, when a receiver wants a higher level of service (e.g., higher picture quality or a higher resolution) and the wanted level of service requires a network bandwidth larger than a current network bandwidth, network congestion may occur. Likewise, this may degrade QoE and leads to dissatisfaction of a user.

Particularly, in the case of a transmission control protocol (TCP) network which is used for security in most companies, service quality is further degraded by congestion, and it is difficult to cope with the degradation, compared to an unreliable network such as a user datagram protocol (UDP) network.

Consequently, there is a necessity of a method for minimizing QoE degradation by controlling congestion while transmitting packets in real time in a TCP network environment even when an available bandwidth is reduced. Also, there is a necessity of a method for minimizing QoE degradation even when a user wants a high level of service requiring a bandwidth larger than an available bandwidth.

### SUMMARY

Aspects of the present disclosure provide a packet transmission method for improving the quality of a multimedia service and an apparatus for performing the method.

It should be noted that objects of the present invention are not limited to the above-described objects, and other objects of the present invention will be apparent to those skilled in the art from the following descriptions.

According to an aspect of the inventive concept, there is provided a method for a packet transmission apparatus to transmit a packet in real time, the method comprises determining, by the packet transmission apparatus, whether a buffer occupancy (an occupancy of a buffer) is a threshold value or more, in response to determining the buffer occupancy is greater than or equal to the threshold value, extracting, by the packet transmission apparatus, a degree of influence of the packet on quality of experience (QoE) and in response to determining the degree of influence of the packet on QoE is less than or equal to a predetermined value, dropping, by the packet transmission apparatus, the packet before the packet is transmitted to a network.

According to another aspect of the inventive concept, there is provided a method for a packet transmission apparatus to transmit a packet in real time, the method comprises receiving, by the packet transmission apparatus, a request for a service of a second quality from a user terminal to which the service is being provided with a first quality that is lower than the second quality, transmitting, by the packet transmission apparatus, packets for providing the service with the first quality to the user terminal in a duplicate manner while providing the service to the user terminal with the first quality, increasing, by the packet transmission apparatus, a transmission amount of the packets transmitted in the duplicate manner until a sum of the transmission amount of the packets for providing the service with the first quality and the transmission amount of the packets transmitted in the duplicate manner is equal to the transmission amount of the packets for providing the service with the second quality and in response to network congestion being sensed while increasing the transmission amount of the packets transmitted in the duplicate manner, notifying, by the packet transmission apparatus, the user terminal that it is not possible to provide the service with the second quality, and providing the service with the first quality.

According to another aspect of the inventive concept, there is provided a packet transmission apparatus comprises a memory configured to store a computer program and at least one processor configured to read and execute the computer program, wherein the computer program comprises a network congestion detection operation of determining whether a buffer occupancy is greater than or equal to a threshold value, extracting a degree of influence of a packet on quality of experience (QoE) in response to the buffer occupancy being greater than or equal to the threshold value, and sensing network congestion based on whether the degree of influence of the packet on QoE is less than or equal to a predetermined value and a rate decreasing operation of dropping the packet before the packet is transmitted to a network in response to being less or equal to the degree of influence of the packet on QoE is the predetermined value.

According to another aspect of the inventive concept, there is provided a non-transitory computer-readable medium having stored thereon a computer program, which when executed by a processor of a packet transmission apparatus, causes the packet transmission apparatus to determine whether a buffer occupancy is greater than or equal to a threshold value, extract a degree of influence of a packet on quality of experience (QoE) in response to the buffer occupancy being greater than or equal to the threshold value or more and drop the packet before the packet is transmitted to a network in response to the degree of influence of the packet on QoE being less than or equal to a predetermined value.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a diagram illustrating a method of transmitting a packet in an existing real-time multimedia service;

FIG. 2 is a diagram illustrating a configuration of an apparatus for transmitting a packet in a real-time multimedia service according to an exemplary embodiment of the present disclosure;

FIG. 3 is flowchart illustrating a method of reducing a data transmission amount in a packet transmission method according to an exemplary embodiment of the present disclosure;

FIG. 4 is a flowchart illustrating a method of increasing a data transmission amount in a packet transmission method according to an exemplary embodiment of the present disclosure;

FIGS. 5 and 6 are graphs comparatively illustrating a related method of processing a request of a user and a method of processing a request of a user according to an exemplary embodiment of the present disclosure;

FIG. 7 is a diagram illustrating another configuration of an apparatus for transmitting a packet in a real-time multimedia service according to an exemplary embodiment of the present disclosure;

FIG. 8 is a graph illustrating performance of a method of transmitting a packet in a real-time multimedia service according to an exemplary embodiment of the present disclosure; and

FIG. 9 is a hardware configuration diagram of an apparatus for transmitting a packet in a real-time multimedia service according to an exemplary embodiment of the present disclosure.

### DETAILED DESCRIPTION OF THE EMBODIMENTS

Hereinafter, the present disclosure will be described in further detail with reference to the accompanying drawings. Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like numbers refer to like elements throughout.

Unless otherwise defined, all terms including technical and scientific terms used herein have the same meaning as commonly understood by one of ordinary skill in the art to which this invention belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

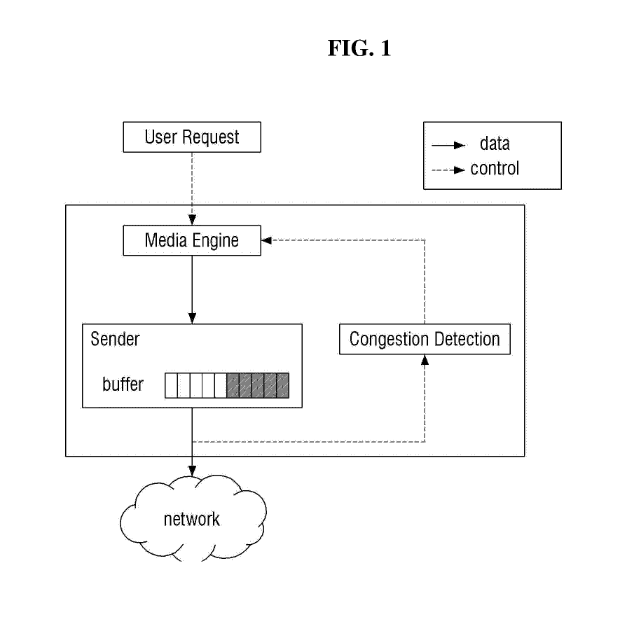

FIG. 1 is a diagram illustrating a method of transmitting a packet in an existing real-time multimedia service.

An unreliable network technology, that is, a user datagram protocol (UDP) manner in which a packet is dropped when network congestion occurs, is preferred by a general multimedia service. However, in most corporation-oriented services, it is not possible to use the UDP due to security, a firewall, and the like, and it is frequently forced to use the transmission control protocol (TCP) instead of the UDP.

Since the TCP provides a reliable transmission mechanism in which retransmission is attempted when a packet transmission fails, the TCP is not suitable for a real-time multimedia service for transmitting packets within a certain time. In other words, when congestion occurs in a real-time multimedia service, such a TCP feature may cause a transfer delay of tens of seconds and remarkably degrade quality of experience (QoE). Therefore, a method for controlling network congestion is required for TCP-based real-time multimedia transmission.

Referring to FIG. 1, among related methods for controlling network congestion, a method employing a media engine is illustrated. According to related methods, network congestion is controlled by adjusting a resolution or a frames-per-second (FPS) of a video which is provided in real time by a media engine.

For example, it is assumed that a user makes a request to improve a resolution or picture quality of a multimedia currently being provided. This user request is transmitted as a control command via a network. However, for convenience of understanding, FIG. 1 shows that the control command of the user is directly transferred to a media engine of a server.

Then, the media engine elevates the picture quality or the resolution of the video according to the user request and generates data packets. The data packets generated by the media engine are transferred to a sender. The sender has a buffer and sequentially transmits the data packets to the network. A receiver of a client which is connected to the opposite side of the network receives the data packets and provides the video and audio to the user in real time.

There is a congestion detection module for sensing network congestion in the server. When congestion is sensed, congestion is fed back to the media engine. Then, the media engine notifies the user that it is not possible to provide a service of quality requested by the user, generates multimedia data packets with the resolution or the picture quality before the request, and transfers the generated data packets to the sender.

In this process, while the congestion detection module senses and feeds the network congestion back to the media engine, the user is not able to receive the real-time multimedia service normally. The user experiences freezing or buffering which frequently occurs when a video conference is held or a video streaming service is used via the network.

Also, although the congestion detection module senses and feeds the network congestion back to the media engine, the server notifies the user that it is not possible to process the request, and the media engine generates data packets with the lowered quality of multimedia service, network congestion is not immediately relieved.

This is because network congestion may last until packets, which are generated by the media engine and wait in a buffer of the sender before the media engine generates the data packets with lowered quality to relieve network congestion, are transmitted via the network.

FIG. 1 shows a case in which network congestion does not occur at quality of a multimedia currently being provided but occurs in a process of fulfilling a request of a user for a service of higher quality. In this case, it is possible to avoid network congestion by ignoring the request of the user.

For example, when the user uses a video streaming service with a resolution of 360p, network congestion does not occur, but when the user requests the service with a resolution of 720p, network congestion occurs, and the service may be provided with a resolution of 360p again. In this case, network congestion occurs due to the request of the user, and when packets are transmitted with the resolution of 360p which is the original quality again, the network congestion may be relieved.

However, network congestion may also occur in cases other than the case of FIG. 1. In other words, network congestion may occur not only in a process of providing a service of quality requested by a user but also due to circumstances of a network for transmitting multimedia data.

For example, while a user uses a service normally with the resolution of 360p, network congestion may occur due to network circumstances. In this case, the method of relieving network congestion by using a media engine provides the service with lower quality than that currently used by the user to relieve congestion.

When network congestion occurs while a user uses a service with the resolution of 360p, the service may be provided with a resolution of 240p which is lower than the resolution of 360p to relieve the network congestion. However, there is a problem in that the network congestion is not necessarily relieved by lowering the resolution to 240p. In this case, the media engine may further lower the resolution from 240p to 144p to relieve the network congestion.

Like this, when network congestion occurs due to network circumstances while a service is provided normally, current quality of the service is lowered to relieve the network congestion. However, in general cases, resolutions and FPSs which may be provided by a system are limited in number. Also, after the provision of a service is started, it is difficult to add or modify a resolution and an FPS.

Therefore, it is difficult to minutely control a transmission amount in units of packets only according to the method of adjusting the amount of data packets by adjusting multimedia quality in a media engine. Also, when congestion occurs, it is not possible to control packets which have been generated already, and it is difficult to rapidly control network congestion.

In addition to the method of controlling congestion by resolution and FPS adjustment of a media engine, there are some more related methods for controlling network congestion. For example, there is a TCP-based congestion control method referred to as an additive increase/multiplicative decrease (AIMD) scheme. Also, there is a congestion control method in which a video codec specialized for multimedia is used.

The AIMD scheme is frequently used in existing wired and wireless networks. First, the amount of generated data is slowly increased until congestion occurs (additive increase), and when congestion is detected, a transmission amount is reduced to half or less to avoid congestion (multiplicative decrease).

The AIMD scheme may be suitable for general data transmission but is inefficient to be used in real-time multimedia transmission in which it is necessary to ensure real-time transmission. Particularly, in the case of the TCP, basic congestion control mechanisms of Linux and Windows are implemented in the kernel layer that a user is unable to handle, and thus it is difficult to modify and use the basic congestion control mechanisms with a general solution.

Also, the congestion control method in which the video codec is used employs concepts of a base layer and an enhancement layer to control a transmission amount. A base layer is necessarily generated, and an enhancement layer is generated as necessary, so that the amount of a generated multimedia is adjusted. A representative example is a scalable video codec (SVC) such as H.264 SVC.

However, according to a method of controlling a data amount in units of layers, a data amount is controlled in units of layers, and thus it is difficult to minutely control a data amount in units of packets. Also, since a multimedia service becomes dependent on a corresponding codec, a media engine is required to support the codec, and otherwise, it is necessary to change media engines.

Further, a specific codec may require the cost of a license. Moreover, codec-level control uses a media engine, and thus it is not possible to control congestion caused by packets which have been generated already and accumulated in a transmission buffer before network congestion occurs.

Thus far, a related general TCP-based congestion control method and a method of controlling congestion by adjusting a codec, a resolution, or an FPS through a media engine in a multimedia service have been described with reference to FIG. 1.

These related methods have a demerit that it is difficult to minutely control congestion in units of packets. Also, congestion may last until the congestion is sensed and a media engine handles the congestion. Further, although the media engine handles the congestion, it is not possible to avoid congestion caused by data which has already been accumulated in a buffer.

To solve these problems, there is a necessity of a network congestion control method for controlling the amount of network transmission in units of packets and also controlling the amount of network transmission in real time when network congestion is sensed.

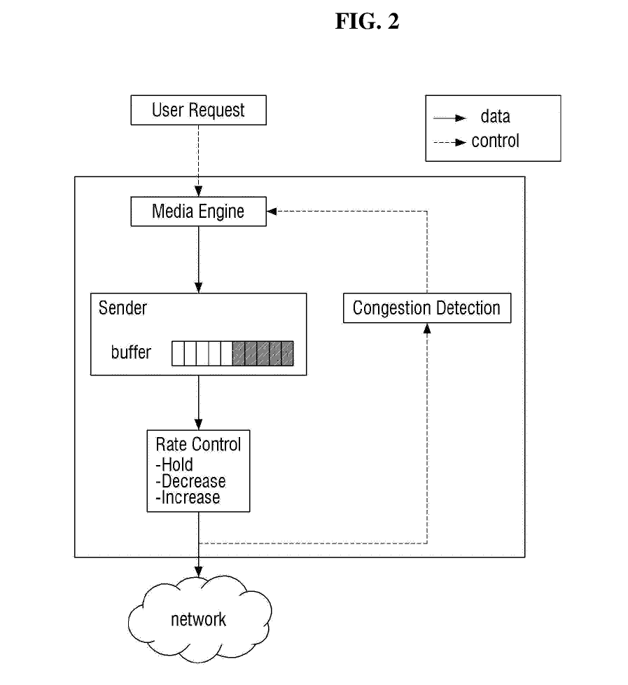

FIG. 2 is a diagram illustrating a configuration of an apparatus for transmitting a packet in a real-time multimedia service according to an exemplary embodiment of the present disclosure.

Referring to FIG. 2, unlike FIG. 1, a rate control module is added between a sender and a network. Through the module, it is possible to hold, decrease, or increase multimedia data packets in units of packets.

As shown in FIG. 2, according to a network congestion control method proposed in the present disclosure, an additional transmission amount is controlled to relieve network congestion at a buffer end immediately before transmission of multimedia data, unlike a related method of controlling a data amount at a time point when multimedia data is generated.

In this way, it is possible to minutely adjust a data amount in units of packets. Also, even data which has already been generated and stored in a buffer may be filtered immediately before transmission. Further, the network congestion control method has no dependency on a specific codec and may be compatibly used with an existing system only by adding a rate control module to the existing system without replacing the existing system.

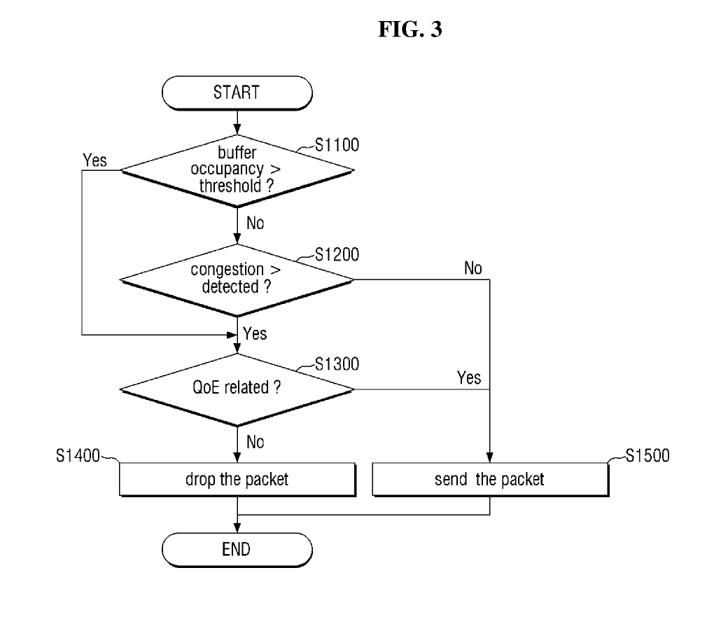

According to the network congestion control method proposed in the present disclosure, in two cases in which network congestion may occur, the congestion is controlled as follows. First, when congestion occurs due to network circumstances, packets are intentionally dropped to control the network congestion. This will be described in detail below with reference to FIG. 3.

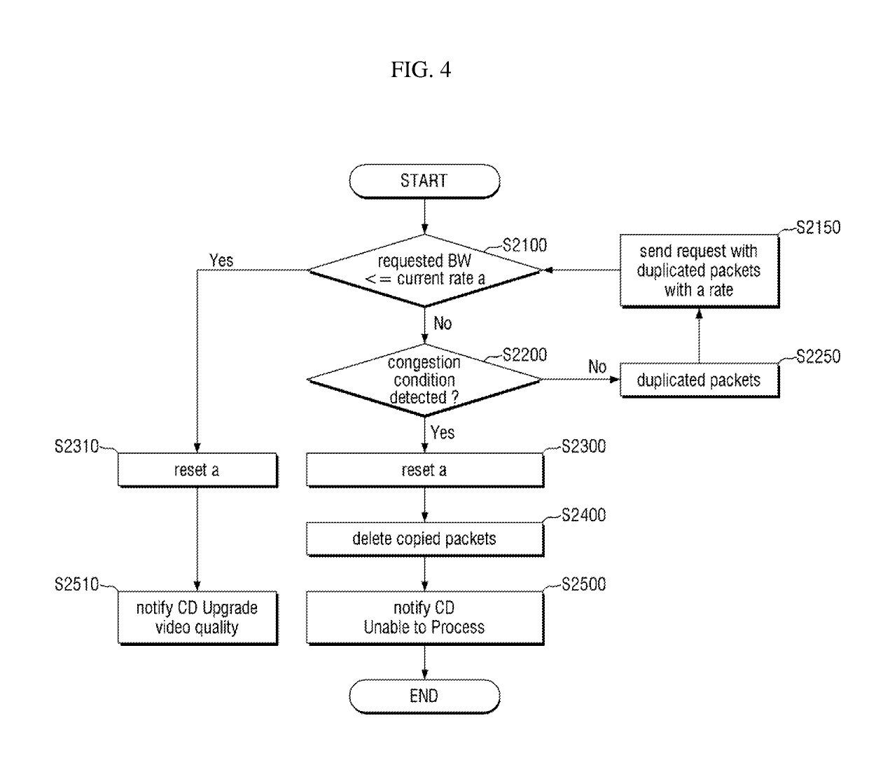

Second, when congestion occurs due to a user's request for a high-quality service exceeding an available bandwidth, it is determined whether a network bandwidth may support the high-quality service by using duplicate packets of multimedia data in response to the request of the user, and the service is provided, so that network congestion is minimized. This will be described in detail below with reference to FIGS. 4 to 6.

Referring to FIG. 2, a network congestion control apparatus proposed in the present disclosure includes a media engine for generating media data, a congestion detection module for sensing network congestion, a sender for handling data transmission, and a rate control module for controlling a transmission rate in units of packets at a transmission buffer end.

The media engine generates multimedia data including a video and audio and determines the amount of generated data according to a user request or network congestion. The generated multimedia data is transferred to the sender. Generally, the sender includes a buffer to avoid congestion and control a transmission amount. Lastly, the rate control module determines whether to additionally increase or decrease the transmission amount according to conditions after the transmission buffer and controls the amount of data transferred to the network.

In particular, the network congestion control method proposed in the present disclosure may be effectively used in a solution such as a video conference. As an existing video conferencing solution, there is WebEx of Cisco Inc. According to a survey made in 2013 by a market research company, WebEx was ranked first with a market share of 52% all over the world and is a video conferencing solution used by 90% of leading 500 companies ranked by the Fortune magazine.

However, the WebEx solution also controls network congestion by adjusting a transmission amount through combination of a resolution and an FPS as described above. The WebEx solution begins with a low resolution to avoid network congestion and gradually increases the resolution and an FPS to provide as high resolution as possible to a user.

When a higher bandwidth than a bandwidth available for a user is used, a resolution and an FPS are lowered to avoid network congestion. According to this method, it takes a long time to provide the highest resolution. Also, as mentioned above, since a media engine determines a transmission amount of multimedia data, it is difficult to process packets which have already been generated. Further, during a process of increasing a resolution, a screen may be interrupted or lag due to a bandwidth difference.

The method proposed in the present disclosure differs from the WebEx solution in that a data transmission end controls network congestion. Since a location where a transmission amount is determined is close to a sender, it is possible to rapidly and flexibly control the transmission amount. Also, since the transmission amount is controlled in units of packets, it is possible to minutely control the transmission amount.

Further, related methods involve sensing the degree of network congestion only according to network conditions and controlling a transmission amount, whereas the method proposed in the present disclosure involves determining a transmission amount by considering the degree of network congestion, an internal condition (an occupancy ratio of packets in a buffer), an external condition (a user request), and the importance of data.

FIG. 3 is flowchart illustrating a method of reducing a data transmission amount in a packet transmission method according to an exemplary embodiment of the present disclosure.

Referring to FIG. 3, according to the network congestion control method proposed in the present disclosure, when network congestion occurs due to network circumstances, packets are randomly dropped to reduce a data transmission amount. However, packets are not recklessly dropped, and data to be dropped is selected by using three criteria.

According to a buffer occupancy which is a first criterion, whether to transmit a packet is determined (S1100). A buffer occupancy may be calculated by considering the amount of packets waiting to be transmitted and an estimated transmission time of packets waiting in a buffer. In other words, although network congestion is not sensed, a packet transmission apparatus may drop packets when the amount of packets waiting in a buffer is a threshold value or more. A buffer which is being filled with packets waiting to be transmitted denotes that network congestion may occur soon because only an insufficient available bandwidth remains.

Therefore, when the amount of packets waiting to be transmitted in the buffer is the threshold value or more, it is necessary to ensure an available bandwidth and prevent network congestion by intentionally dropping packets. Needless to say, even when the amount of packets waiting to be transmitted in the buffer is the threshold value or more, all packets are not dropped and are selectively dropped (S1400).

When the buffer occupancy is not a preset threshold value or more, a network state is checked as a second criterion (S1200). When network congestion is sensed, a corresponding packet may be dropped. On the other hand, when network congestion is not sensed, that is, when there is a sufficient available bandwidth, the corresponding packet may be transmitted to a network (S1500).

When the buffer occupancy is the threshold value or more (S1100) or network congestion is sensed (S1200), it is necessary to intentionally drop the packet to relieve network congestion. In this case, QoE is taken into consideration as a third criterion (S1300).

Multimedia data packets may have different influences on QoE according to size and importance thereof. For example, assuming that data packets are related to a video conference, a packet related to audio or a control command rather than a video has a greater influence on QoE. In other words, when the buffer occupancy is the threshold value or more (S1100) or network congestion is sensed (S1200), video packets may be dropped first (S1400).

Since a video packet has a greater size than an audio packet or a control command packet, removal of video packets is efficient in relieving congestion. On the other hand, an audio packet and a control command packet have a small size and may have a significant influence on QoE when dropped.

Therefore, relatively subordinately, it is necessary to determine whether to drop an audio packet or a control command packet. In general, degree of influence on QoE is in the order of “a video>audio>control command”. Therefore, when packets to be dropped are selected, video packets, audio packets, and control command packets are sequentially selected and dropped (S1400).

To sum up, according to the method of reducing a data transmission amount in the network congestion control method proposed in the present disclosure, when the amount of packets accumulated in an internal buffer of a sender is a threshold value or more or a condition for controlling network congestion is satisfied, it is possible to attempt to drop a packet to relieve congestion.

Here, a buffer occupancy may be determined on the basis of an occupancy ratio of media packets in a buffer, an estimated transmission time of packets in the buffer, and the like. Also, whether a network is congested may be determined by the congestion detection module through a signal input, sensing a change in network parameters, and the like.

All packets are not dropped, and only packets which are little related to QoE, that is, packets less influential to QoE, are selectively dropped. In general, video packets, audio packets, and control command packets may be dropped in sequence. Such packet dropping may continue until the condition for controlling network congestion is not fulfilled or the amount of packets waiting to be transmitted in the buffer becomes less than the threshold value.

Here, the preset threshold value may be set differently according to quality of a multimedia being provided. For example, when quality of a multimedia being provided is low, the amount of data to be transmitted in real time is small. In this case, even if the threshold value is relatively high, there is ample time until the buffer is filled up.

On the other hand, when quality of a multimedia being provided is high, the amount of data to be transmitted in real time is large. In this case, even if the threshold value is relatively low, the buffer may be filled up soon. Therefore, the threshold value may be set to an appropriate value by considering multimedia quality.

FIG. 4 is a flowchart illustrating a method of increasing a data transmission amount in a packet transmission method according to an exemplary embodiment of the present disclosure.

Referring to FIG. 4, it is possible to see a method of improving service quality. In other words, it is possible to see a process of minimizing network congestion which may occur in a process of providing, when a user requests a service of higher quality than that currently being provided, the service with the corresponding quality.

When the user requests a higher quality of service, most solutions for transmitting a packet first transmit data of the quality which is requested by the user and higher than a current quality to the user. Then, when network congestion occurs, most solutions notify the user that it is not possible to provide the service with the high quality requested by the user and provide the service with the original quality.

At this time, in the process of receiving the service with the original quality again, the user experiences video lag or interruption caused by network congestion. This may directly lead to QoE degradation. To solve this problem, it is inappropriate to immediately provide the service with the quality requested by the user, and a process of checking whether the quality is available without causing network congestion is necessary.

To this end, in the method proposed in the present disclosure, before high-quality data is transmitted, duplicate packets are generated to check an available bandwidth. Duplicate packets may be easily dropped by checking duplicate receiving at a receiving end. Also, even when network congestion occurs in an increased transmission process, the user may hardly experience a change in quality.

Like this, the method of increasing a data transmission amount proposed in the present disclosure may be further effective when there are small kinds of picture quality which may be provided by a media engine or there are a small number of FPSs which may be provided by the media engine. In other words, the larger a bandwidth difference between levels of picture quality provided by the media engine (e.g., 360p→720p), the greater the effect.

Referring to FIG. 4, it is determined whether a bandwidth of quality requested by the user (requested BW) is larger than a transmission amount (a) currently being transmitted (S2100). Since the user requests a service of higher quality than that currently being provided, a first determination result of operation S2100 is No, and the process proceeds to operation S2200.

Next, it is determined whether congestion is sensed in a network (S2200).

When network congestion is not sensed, there is a sufficient available bandwidth, and the transmission amount (a) is increased (S2250). However, the transmission amount (a) is increased in a manner of duplicating only some of packets and transmitting the duplicate packets while providing the service of the same quality as currently being provided (S2150).

A transmission amount is gradually increased (S2250) by transmitting some of packets in a duplicate manner until the transmission amount corresponds to the bandwidth of the quality requested by the user (S2100) as long as network congestion does not occur (S2200).

When the transmission amount increases up to the bandwidth of the quality requested by the user, that is, when the determination result of operation S2100 is Yes, it is possible to provide the service with the quality requested by the user without network congestion. Therefore, the user is notified that the video quality is upgraded (S2510), and the service is provided with the quality requested by the user.

A related method involves providing, when a user requests a higher quality of service, the service to the user with the corresponding quality and providing the service to the user with an original quality when network congestion occurs, whereas the present disclosure involves duplicating a gradually increasing amount of packets, determining whether it is possible to provide the service with the quality requested by the user while transmitting the duplicate packets, and upgrading the original quality to the quality requested by the user only when it is possible to provide the service with the quality requested by the user.

When network congestion occurs while the transmission amount is gradually increased (S2100→S2200→S2250→S2150), the determination result of operation S2200 becomes Yes, and the process proceeds to operation S2300. In other words, the gradually increased transmission amount is reset (S2300). Then, packets being duplicated are deleted (S2400), a notification that it is not possible to provide the service with the quality requested by the user is provided (S2500), and the service may be provided with the original quality.

The process of increasing the transmission amount (S2100→S2200→S2250→S2150) in FIG. 4 is performed in a manner of duplicating only some of packets and transmitting the duplicate packets while providing the service with the original quality. Therefore, until the quality is actually upgraded (S2510), the user uses the service with the original quality. This is because data transmitted in a duplicate manner is automatically processed as a duplicate and excluded at a receiver of a client when the service is provided.

When the method proposed in the present disclosure is used, it is advantageous in that screen interruption or lag is hardly caused by network congestion because a user continuously uses a service with an original quality even if it is not possible to provide the service with a quality requested by the user.

For example, it is assumed that a user is using a multimedia service with a resolution of 360p. Then, a bandwidth value for transmitting packets with the resolution of 360p is stored as a current transmission amount (a). Next, when the user requests the service with a resolution of 720p, the stored bandwidth value is compared with a bandwidth required to provide the service with the resolution of 720p (S2100).

In this case, since the bandwidth required to provide the service with the resolution of 720p requested by the user is larger than the bandwidth corresponding to the current resolution of 360p, a comparison result of operation S2100 is No, and the process proceeds to operation S2200, so that it is determined whether network congestion is sensed (S2200).

Since network congestion is not sensed, the transmission amount (a) is continuously increased (S2250) through an operation of duplicating some packets (S2150) while the service is provided to the user with the resolution of 360p. When the transmission amount (a) is gradually increased in this way up to an amount sufficient to provide the service with the resolution of 720p requested by the user, the user is notified that the video quality is upgraded (S2510), and the service is provided with the changed resolution of 720p.

However, when network congestion occurs while the transmission amount (a) is gradually increased, it is not possible to provide the service with the quality requested by the user. Therefore, the increased transmission amount (a) is reset to a value for providing the service with the original quality of 360p (S2300), and duplicated packets among packets waiting to be transmitted in the buffer are deleted to immediately relieve network congestion (S2400). Also, the user is notified that it is not possible to provide the service with the requested quality (S2500).

To sum up, when a user requests an increase in video resolution and a large bandwidth is required compared to a transmission amount currently being sent, an attempt is not immediately made with the corresponding bandwidth, and whether congestion occurs is determined by transmitting duplicate packets while the transmission amount is increased.

In other words, a bandwidth which is available for the service is estimated with additional data which has no influence on an original quality. Even when duplicate packets are received, a receiver is able to easily exclude the duplicate data and provide a service by checking packet headers and media data or in another way, and thus an existing system is not affected.

When network congestion is sensed through a change in network parameters and a change in the size of the transmission buffer while the transmission amount is increased, the user is notified that it is not possible to process the request, and the increased resolution is restored to an original resolution. At this time, duplicate packets in the transmission buffer are deleted to rapidly relieve the network congestion.

Even when the congestion occurs, the user may maintain an original picture quality while experiencing only slight degradation of service quality caused by a resolution change. On the other hand, when an available bandwidth is increased to the requested bandwidth or more without any problem, the congestion detection module requests the media engine to increase the resolution. Virtually increased data is replaced with video data having a high resolution.

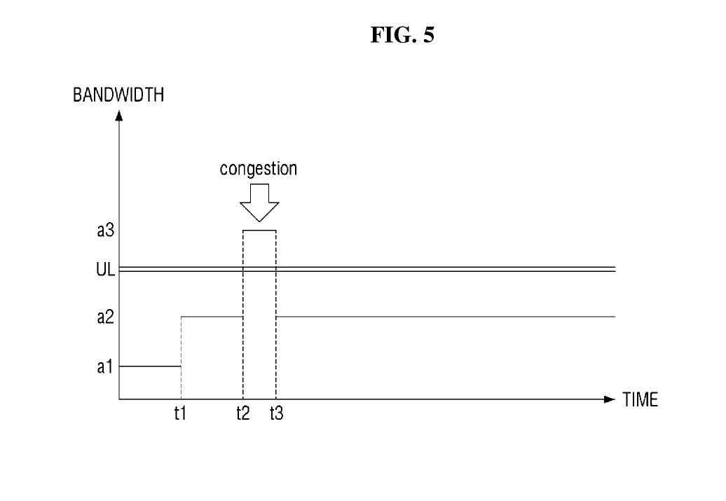

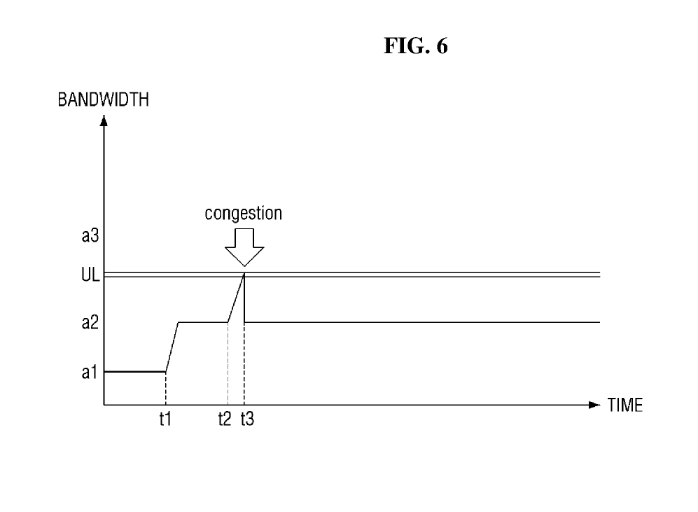

FIGS. 5 and 6 are graphs comparatively illustrating a related method of processing a request of a user and a method of processing a request of a user according to an exemplary embodiment of the present disclosure.

Referring to FIG. 5, it is possible to see a related method of processing a request of a user. First, a service is provided with quality q1 until a time point t1. When a user requests quality q2 at the time point t1, the service is immediately provided with the quality q2 according to the related method. Since the quality q2 requires a bandwidth smaller than a bandwidth upper limit (UL) at which network congestion occurs, it is possible to provide the service normally.

Therefore, the service is provided with the quality q2 between the time point t1 and a time point t2. Assuming that the user requests again quality q3 at the time point t2, the service is immediately provided with the quality q3 according to the related method. However, the quality q3 requires a bandwidth larger than the bandwidth UL at which network congestion occurs.

Therefore, network congestion occurs at the time point t2 at which the service is provided with the quality q3. Then, according to a related method such as WebEx, the user is notified that it is not possible to provide the service with the quality q3, and the service is provided again with the lowered quality q2.

However, QoE may be degraded between the time point t2 at which the service is provided with the quality q3 and the time point t3 at which the service is provided again with the quality q2 lowered due to the network congestion. In other words, the network congestion may cause a screen interruption or buffering.

In particular, even when the network congestion is sensed, a media engine generates high-quality data until the network congestion is handled, and a considerable time is required to transmit the data generated and accumulated in a buffer. Therefore, QoE degradation may last for a long time, and the user may have complaints.

On the other hand, referring to FIG. 6, it is possible to see a process of processing a request of a user in a different way according to the present disclosure. According to the present disclosure, even when a user requests a high quality of service, the service is not immediately provided with the high quality, and a process of determining whether it is possible to provide the service with a corresponding bandwidth is performed first.

Referring to FIG. 6, the service is provided with quality q1 until a time point t1. When the user requests quality q2 at the time point t1, only a data amount is gradually increased while the service is provided with the quality q1 until it is possible to provide the service with the quality q2.

When it is determined that there is a sufficient bandwidth to provide the service with the quality q2, the service is provided with the quality q2 from a time point at which the determination is made. In this way, the service is provided with the quality q2 until a time point t2, and the user requests the service with quality q3 at the time point t2. Then, likewise, the service is not immediately provided with the quality q3, and a transmission amount is gradually increased by duplicating packets while the service is continuously provided to the user with the quality q2.

When the transmission amount increases up to a bandwidth UL at which network congestion occurs, it is determined that it is not possible to increase the transmission amount any more, and the user is notified that it is not possible to provide the service with the requested quality. Then, the service is continuously provided with the quality q2 which is the previous quality.

Referring to FIG. 6, a time between the time points t2 and t3 is before congestion occurs. At the time point t3, although congestion temporarily occurs, duplicate data stored in a buffer is deleted, and the service is continuously provided with the quality q2 which is the existing quality. Therefore, the user hardly experiences network congestion. Consequently, almost no QoE degradation occurs.

In other words, network congestion occurs between the time points t2 and t3 according to the related method illustrated in FIG. 5, whereas network congestion occurs only at the time point t3 according to the method proposed in the present disclosure illustrated in FIG. 6. Like this, use of the method proposed in the present disclosure may minimize network congestion, and this may lead to an improvement in QoE.

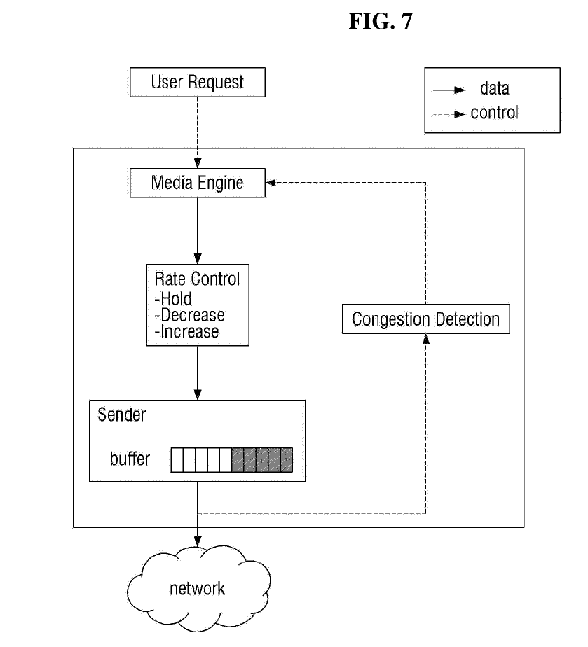

FIG. 7 is a diagram illustrating another configuration of an apparatus for transmitting a packet in a real-time multimedia service according to an exemplary embodiment of the present disclosure.

Although the rate control module is between the sender and the network in FIG. 2, the rate control module may be between the media engine and the sender. When the location of the rate control module is changed, there are slight disadvantages compared to FIG. 2.

As regards demerits of related network congestion control methods again, even when a congestion detection module senses network congestion, it is necessary to reduce the amount of data generated by a media engine so as to relieve the network congestion. Therefore, 1) data, which is generated until the media engine reduces the data amount after the network congestion is sensed, is transmitted as is via a network, and 2) even when the media engine reduces the data amount, data accumulated in a buffer is transmitted as is via the network.

To solve these problems, in FIG. 2, a method of relieving network congestion by placing the rate control module between the buffer and the network and dropping packets immediately after congestion is sensed as long as not affecting QoE has been proposed. In this way, when the rate control module is placed between the buffer and the network, it is possible to overcome both the demerits of related methods.

On the other hand, when the rate control module is placed between the media engine and the buffer as proposed in FIG. 7, it is possible to control data between a time point at which network congestion occurs and a time point at which the media engine reduces the data amount, that is, it is possible to overcome a demerit of related methods. However, data which has already been accumulated in the buffer is transmitted as is to the network and may worsen the network congestion.

Among the two demerits of related methods, the first demerit that data, which is generated until a media engine reduces a data amount after network congestion is sensed, is transmitted as is via a network is generally greater than the second demerit that even when the media engine reduces the data amount, data accumulated in a buffer is transmitted as is via the network. Therefore, even when the location of the rate control module is changed as shown in FIG. 7, it is possible to achieve effects to some degree.

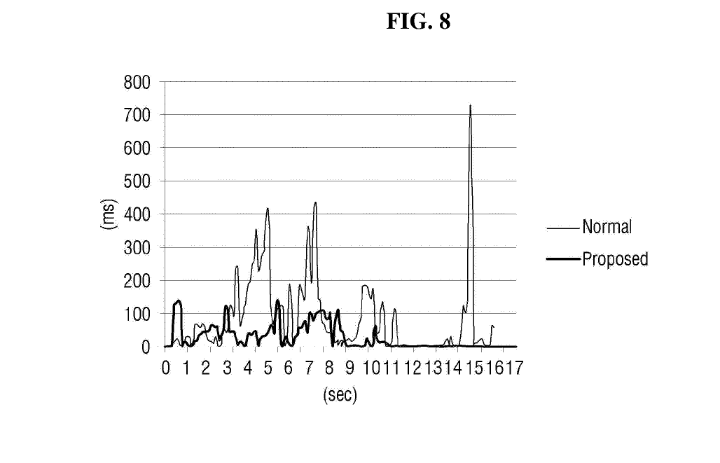

FIG. 8 is a graph illustrating performance of a method of transmitting a packet in a real-time multimedia service according to an exemplary embodiment of the present disclosure.

Referring to FIG. 8, it is possible to see delays caused by packets in a transmission buffer according to a general packet transmission method (Normal) and the packet transmission method proposed in the present disclosure (Proposed) when network congestion occurs. In the graph of FIG. 8, a long delay denotes that network congestion lasts for a long time.

In the case of the related method (Normal), when network congestion occurs, a media engine reduces the amount of generated data. However, since data is reduced in units of resolutions, FPSs, or layers, it is difficult to minutely control the network congestion. Also, since already generated packets are transmitted as is to a network, a delay is caused by the packets in a transmission buffer.

Referring to FIG. 8, according to the related method, when network congestion occurs (bandwidth is limited to 800 kbps), it takes about 15 seconds or more to completely relieve the congestion, and a user experiences screen interruption due to a delay of 400 ms or more. For this reason, QoE is degraded.

The method proposed in the present disclosure may be used together with the related method in which a media engine is used. In other words, network congestion may be rapidly relieved by reducing the amount of data generated by a media engine and also selectively dropping some of data transmitted via a network.

Referring to FIG. 8, according to the method proposed in the present disclosure, congestion is completely relieved faster (about 10 seconds) than the related method, and a relatively constant buffer delay of 150 ms or less is shown even in a congestion section. In general, a delay of 200 ms or less has no significant influence on QoE. In other words, according to the method proposed in the present disclosure, intermittent and short lag may be caused by dropping some video packets, but service quality may be improved because there are fewer screen interruptions and network congestion is rapidly relieved compared to the related method.

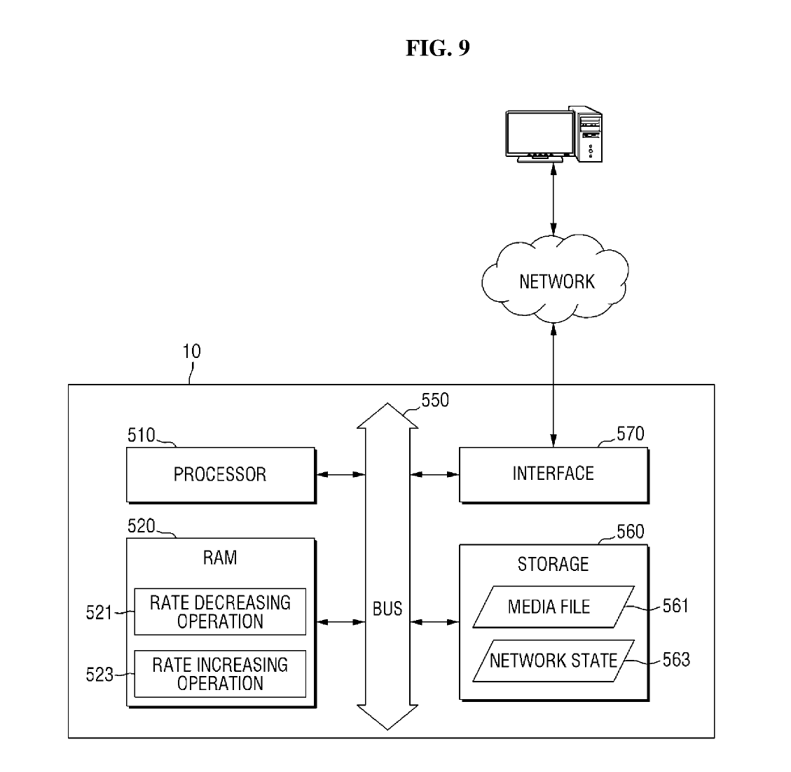

FIG. 9 is a hardware configuration diagram of an apparatus for transmitting a packet in a real-time multimedia service according to an exemplary embodiment of the present disclosure.

Referring to FIG. 9, an apparatus 10 for transmitting a packet in a real-time multimedia service proposed in the present disclosure may include at least one processor 510, a memory 520, a storage 560, and an interface 570. The processor 510, the memory 520, the storage 560, and the interface 570 exchanges data via a system bus 550.

The processor 510 executes a computer program loaded onto the memory 520, and the memory 520 loads the computer program from the storage 560. The computer program may include a network congestion detection operation (not shown), a rate decreasing operation 521, and rate increasing operation 523.

The network congestion detection operation (not shown) involves periodically or aperiodically monitoring a network state 563 so as to sense network congestion and storing the network state 563 in the storage 560.

The network congestion detection operation (not shown) involves sensing network congestion on the basis of the network state 563 stored in the storage 560, and a sensing result of the network congestion detection operation may be used to increase or decrease the amount of data transmitted when data generated by a media engine is transmitted to a terminal of a user.

The rate decreasing operation 521 is performed to provide a media file 561 stored in the storage 560 to a user via a network or to control network congestion due to network circumstances.

In the rate decreasing operation 521, packets may be dropped from data to be transmitted in order of increasing relation to QoE when network congestion occurs or by considering the amount of data stored in a buffer or a rate at which data is accumulated in the buffer.

The rate increasing operation 523 is performed to determine, when a user requests a service of higher quality than that currently used by the user, whether it is possible to provide the service with the corresponding quality.

The rate increasing operation 523 involves duplicating some packets and transmitting the duplicate packets in a duplicate manner while providing the media file 561 stored in the storage 560 continuously with a current quality. Then, when there is a sufficient bandwidth to provide the service with the quality requested by the user, the service is provided with the requested quality.

On the other hand, when there is an insufficient bandwidth to provide the service with the quality requested by the user, duplicated packets are deleted, and the service is continuously provided with the current quality. Then, even when network congestion temporarily occurs, the user hardly recognizes the network congestion.

Each component of FIG. 9 may denote software or hardware, such as a field programmable gate array (FPGA) or an application-specific integrated circuit (ASIC). However, the components are not limited to software or hardware and rather may be configured to reside in an addressable storage medium or to execute one or more processors.

Functionality provided within the components may be implemented by subdivided components or one component which is composed of a plurality of components to perform a specific function.

The effects according to the embodiment of the present disclosure are as follows.

When a packet transmission method proposed in the present disclosure is used, it is possible to control congestion of a network through a reduction in the amount of transmission caused by dropping packets or a minute adjustment of the amount of transmission caused by duplicating a packet according to the degree of network congestion. In this way, it is possible to control a transmission rate at a transmission buffer end for multimedia data. In this way, it is possible to minimize network congestion and improve user service quality.

Also, since the method is implemented at a data transmission buffer end, it is possible to control a transmission rate more rapidly and minutely than a transmission amount adjustment method of an existing media engine or codec. In other words, when congestion occurs in a network, it is possible to rapidly minimize the congestion compared to a related method.

Further, the method is implemented independently from an engine for generating a media and thus can be simply applied to an existing multimedia system. Therefore, the method can be used for a video streaming service or a video conference, a video on demand (VOD) service, and the like in a real-time multimedia transmission field.

In addition, the method can be applied to a closed-circuit television (CCTV), a video management system (VMS), a smart home video, a video analysis (VA) function, and the like used for real-time surveillance and security. As an example, the method is applied to minimize network congestion and smoothly adjust the resolution of a meeting by solving a transmission adjustment problem caused in a TCP-based KNOX meeting solution of Samsung SDS Co., Ltd.

The concepts of the invention described above with reference to FIGS. 3 to 7 can be embodied as computer-readable code on a computer-readable medium. The computer-readable medium may be, for example, a removable recording medium (a CD, a DVD, a Blu-ray disc, a USB storage device, or a removable hard disc) or a fixed recording medium (a ROM, a RAM, or a computer-embedded hard disc). The computer program recorded on the computer-readable recording medium may be transmitted to another computing apparatus via a network such as the Internet and installed in the computing apparatus. Hence, the computer program can be used in the computing apparatus.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

While the present invention has been particularly illustrated and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A method for a packet transmission apparatus to transmit a packet in real time, the method comprising:
determining, by the packet transmission apparatus, whether a buffer occupancy is greater than or equal to a threshold value;
in response to determining the buffer occupancy is greater than or equal to the threshold value, extracting, by the packet transmission apparatus, a degree of influence of the packet on quality of experience (QoE); and
in response to determining the degree of influence of the packet on QoE is less than or equal to a predetermined value, dropping, by the packet transmission apparatus, the packet before the packet is transmitted to a network.

2. The method of claim 1, wherein the determining whether the buffer occupancy is greater than or equal to the threshold value comprises calculating the buffer occupancy based on at least one from among a number of packets stored in the buffer and an estimated transmission time of the stored packets.

3. The method of claim 1, wherein the extracting the degree of influence of the packet on QoE in response to the buffer occupancy being greater than or equal to the threshold value comprises extracting the degree of influence of the packet on QoE in response to congestion being sensed in the network while the buffer occupancy is less than the threshold value.

4. The method of claim 1, wherein the extracting the degree of influence of the packet on QoE comprises determining that video packets have less influence on QoE than audio packets.

5. The method of claim 1, wherein the extracting the degree of influence of the packet on QoE comprises determining that audio packets have less influence on QoE than control packets.

6. The method of claim 1, further comprising:
setting, by the packet transmission apparatus, the threshold value to a first threshold value in response to multimedia quality being a first quality; and
setting, by the packet transmission apparatus, the threshold value to a second threshold value higher than the first threshold value in response to the multimedia quality being a second quality that is lower than the first quality.

7. A method for a packet transmission apparatus to transmit a packet in real time, the method comprising:
receiving, by the packet transmission apparatus, a request for a service of a second quality from a user terminal to which the service is being provided with a first quality that is lower than the second quality;
transmitting, by the packet transmission apparatus, packets for providing the service with the first quality to the user terminal in a duplicate manner while providing the service to the user terminal with the first quality;
increasing, by the packet transmission apparatus, a transmission amount of the packets transmitted in the duplicate manner until a sum of the transmission amount of the packets for providing the service with the first quality and the transmission amount of the packets transmitted in the duplicate manner is equal to the transmission amount of the packets for providing the service with the second quality; and
in response to network congestion being sensed while increasing the transmission amount of the packets transmitted in the duplicate manner, notifying, by the packet transmission apparatus, the user terminal that it is not possible to provide the service with the second quality, and providing the service with the first quality.

8. The method of claim 7, further comprising, in response to congestion not being sensed while increasing the transmission amount of the packets transmitted in the duplicate manner, notifying, by the packet transmission apparatus, the user terminal that it is possible to provide the service with the second quality, and providing the service with the second quality.

9. A packet transmission apparatus comprising:
a memory configured to store a computer program; and
at least one processor configured to read and execute the computer program,
wherein the computer program comprises:
a network congestion detection operation of determining whether a buffer occupancy is greater than or equal to a threshold value, extracting a degree of influence of a packet on quality of experience (QoE) in response to the buffer occupancy being greater than or equal to the threshold value, and sensing network congestion based on whether the degree of influence of the packet on QoE is less than or equal to a predetermined value; and
a rate decreasing operation of dropping the packet before the packet is transmitted to a network in response to the degree of influence of the packet on QoE being less than or equal to the predetermined value.

10. A non-transitory computer-readable medium having stored thereon a computer program, which when executed by a processor of a packet transmission apparatus, causes the packet transmission apparatus to:
determine whether a buffer occupancy is greater than or equal to a threshold value;
extract a degree of influence of a packet on quality of experience (QoE) in response to the buffer occupancy being greater than or equal to the threshold value; and
drop the packet before the packet is transmitted to a network in response to the degree of influence of the packet on QoE being less than or equal to a predetermined value.
